(19) United States
(12) Patent Application Publication
(10) Pub. No.: US 2025/0293372 A1
(43) Pub. Date: Sep. 18, 2025

(54) BATTERY TOWER DESIGN FOR HEAVY-DUTY ELECTRIC POWERTRAINS

(71) Applicant: Caterpillar Inc., Deerfield, IL (US)

(72) Inventors: Strauss Langrud, Peoria, IL (US); Wellington Y. Kwok, Dunlap, IL (US)

(73) Assignee: Caterpillar Inc., Deerfield, IL (US)

(21) Appl. No.: 18/604,229

(22) Filed: Mar. 13, 2024

(51) Int. Cl. H01M 50/258; H01M 10/625; H01M 10/647; H01M 10/6556; H01M 50/209; H01M 50/249; H01M 50/264

(52) U.S. Cl. CPC H01M 50/258; H01M 10/6556; H01M 50/209; H01M 50/249; H01M 50/264; H01M 10/625; H01M 10/647; H01M 2220/20

(57) ABSTRACT

This disclosure describes a battery tower design using pouch cell or blade cell batteries to build modular towers and assemble battery units to fit within electrified heavy-duty equipment. The battery units are modular to enable expansion of the battery units horizontally and/or vertically to fit within irregular-shaped compartments originally intended for non-electric powertrain components. The battery towers are modular units with frames for holding battery cells with their width in a vertical direction and stacking the cells vertically along a length of a frame that includes passive and active cooling components.

### TECHNICAL FIELD

The present application relates to battery pack systems for heavy duty powertrain applications. More particularly, the present application relates to a design and system for a cell-to-pack (CTP) assembly to fill a non-traditional installation space (e.g., filling an existing fuel-engine compartment) that incorporates an integrated structural and thermal design that exposes large surfaces of battery cells to a thermal interface for thermal management.

### BACKGROUND

Electrification of heavy-duty and/or offroad systems in large-scale construction equipment and hauling vehicles has grown rapidly in the recent years. In some applications, a traditional diesel engine powertrain is directly replaced by installing a full-electric powertrain integrated with a battery system. Without a complete redesign of the machine or vehicle chassis, the battery system needs to fit within existing spaces on the machine or vehicle chassis.

Typical automotive design configurations for battery systems are in a flat arrangement that is designed specifically to fit in the underbody of a passenger vehicle or floor of an electric bus. Electrification of large machines, equipment, mining trucks, etc., replaces the large diesel engine with electric powertrain and leaves behind a large irregular, often narrow and tall “empty” engine compartment that does not fit well with common battery module or pack designs that are designed for flat arrangements.

Further, cell-to-pack (CTP) battery configurations simplify the manufacturing process and removes intermediate states of manufacturing. Additionally, cell-to-pack arrangements can reduce the weight of the battery pack, thereby improving the energy density. An example CTP battery pack is described in Chinese Patent Publication CN216850179, titled “CTP Battery Pack and Automobile” (hereinafter referred to as the '179 document). In particular, the '179 document describes a CTP battery pack with a box body structure and square-shell battery cells stacked in the box body, with heat-conducting glue coated between the bottom surface of the box body and the bottom surface of each battery cell. The CTP battery back includes two cell groups arranged side by side within the box body and limit strips below the cell groups and therefore provides for a uniform height or thickness of the CTP battery pack.

Although the system described in the '179 document is configured to provide a CTP battery pack, it does not provide for configurable and/or expandable arrangements to enable filling of irregular spaces left behind in heavy-duty machinery by removing previous drivetrain equipment.

An example of a vertically stacked battery structure is described in Japanese Patent Publication JP7120482B1, titled “Storage Battery System” (hereinafter referred to as the '482 document). In particular, the '482 document describes a storage battery system with improved load resistance. The storage battery system include a plurality of battery modules with a pillar portion extending in a stacking direction. The pillar portion includes a pair of pillars arranged apart from each other with a plurality of battery modules between the pair of pillars. The battery modules within the stack are arranged horizontally on top of each other. The battery modules have a rectangular box-shape with the thickness shorter than the length or width. The battery modules are stacked by thickness (e.g., stacked on top of each other such that the stack has a height of n thicknesses).

Although the '482 document describes a stacked battery tower, it provides for the battery cells to be stacked in a horizontal orientation (e.g., stacked along the thickness of the cells) which may create non-uniform compression along the stack of the battery modules.

Examples of the present disclosure are directed toward overcoming the deficiencies described above.

### SUMMARY OF THE INVENTION

In some examples, the systems and techniques described herein may provide a battery unit for fitting within a compartment of a heavy-duty vehicle originally designed for a powertrain component replaced due to electrification of the heavy-duty vehicle. The battery unit includes one or more battery towers to fit within the compartment space in a customizable configuration by adding or reducing the number of battery towers in the battery unit. The battery tower includes a plurality of modular structures, where a modular structure of the plurality of modular structures includes a vertical frame oriented along a first direction, a plurality of horizontal protrusions extending from the vertical frame and defining a plurality of receiving areas on a first side and a second side of the vertical frame. The plurality of receiving areas are shaped to receive a battery cell in a vertical orientation. The battery tower further includes a plurality of battery cells positioned within the plurality of receiving areas, the battery cells having a rectangular prism shape with a length, width, and thickness, where a battery cell of the plurality of battery cells is positioned within a receiving area of the plurality of receiving areas with the length and the thickness arranged perpendicular to the first direction. The battery tower further includes a compressible material positioned on an external surface of the plurality of battery cells to provide a compressible cushion between adjacent modular structures.

In an illustrative example, one general aspect includes a battery module having a housing shaped to fit within a powertrain compartment of a heavy-duty vehicle after a fuel-based powertrain is removed from a chassis of the heavy-duty vehicle. The module may also include a plurality of battery towers arranged within the housing, the plurality of battery towers positioned horizontally with respect to one another, and where a battery tower of the plurality of battery towers may include: a frame may include a plurality of holders for holding a plurality of battery cells, where the plurality of holders retain the plurality of battery cells in a vertical arrangement with a width of respective ones of the plurality of battery cells arranged vertically along a length of the frame; a first heat transfer device arranged along a length of the frame; and a second heat transfer device thermally coupled with the first heat transfer device adjacent a first end of the frame.

The battery cells are stacked in the vertical arrangement such that a largest planar surface of the exterior of the battery cell is exposed to and/or contacts a common space that includes an integrated cooling interface and support structure. The support structure includes a frame of the battery tower with vertical battery cells arranged on each side of the support structure. The support structure provides a thermal interface with one or more cooling devices, such as heat pipes and/or thermal regulation devices. In this manner, the support structure that includes the thermal regulation devices contacting the largest surfaces of the battery cells and providing improved thermal transfer to the thermal regulation devices through the surface of the battery cells. The support structure of the battery tower provides for a cell pair to be positioned on opposite sides of the thermal regulation device (with cell pairs stacked vertically about the thermal regulation device and thereby reduce the number of thermal regulation devices needed for the battery module.

The battery towers may include a vertical frame oriented along a first direction defining a plurality of grooves with an individual groove of the plurality of grooves oriented along a second direction substantially perpendicular to the first direction and extending across a width of the vertical frame and a plurality of shelves connected to the vertical frame, an individual shelf of the plurality of shelves configured to fit within the individual groove and at least partially encircle a perimeter of the vertical frame. The plurality of battery cells may be positioned adjacent the vertical frame and supported by the plurality of shelves, a battery cell of the plurality of battery cells having a rectangular prism shape with a length, width, and thickness, where the battery cell of the plurality of battery cells is positioned within a receiving area of the plurality of receiving areas with the length and the thickness arranged perpendicular to the first direction. The battery tower also includes a compressible material positioned on an external surface of the plurality of battery cells to provide a compressible cushion between adjacent modular structures.

Implementations may include one or more of the following features. The vertical frame may include a heat pipe along the first direction from a first end of the vertical frame to a second end of the vertical frame. The heat pipe is thermally coupled with the cold plate. The heat pipe may include a vapor chamber along the first direction and the cold plate may include an actively cooled heat transfer system. The heat pipe may include a liquid-cooled cold plate. The heat pipe may include a metal portion of the frame along the length of the frame to passively transport heat to the cold plate. The plurality of battery cells are arranged along the vertical frame with alternating positive and negative terminals adjacent one another along the first direction. The battery cell may include a blade cell battery or a pouch cell battery. The compressible material may be adhered to the battery cells and may include a foam, rubber, or other such material.

In some implementations, the vertical frame may include at least one of a heat pipe, a thermally conductive material, a cold plate, a vapor chamber, or another heat transfer device along the first direction from a first end of the vertical frame to a second end of the vertical frame to provide thermal transfer along the first direction. The vertical frame may have a first width at first positions associated with the plurality of grooves and a second width at second positions between the plurality of grooves and each of the plurality of shelves may include a u-shaped component defining an opening having a third width, where the third width is less than the second width and an end component configured to couple to distal ends of the u-shaped component. The u-shaped component includes interfaces at distal ends of the u-shape. The u-shaped component may include a first interface adjacent a first distal end of the u-shaped component and a second interface adjacent a second distal end of the u-shaped component, the end component may include a third interface adjacent a first end of the end component and a fourth interface adjacent a second end of the end component, and the third interface couples with the first interface and the fourth interface couples with the second interface to form the individual shelf. The first interface and the second interface may each define respective openings and the third interface and the fourth interface each define a retaining clip configured to securely interface with the respective openings of the first interface and the second interface. The battery tower may include a thermal management component positioned between adjacent modular structures of the plurality of modular structures, the thermal management component configured to transport heat towards or away from the plurality of battery cells. The modular structure further may include a thermal management component positioned between the plurality of battery cells and the vertical frame, the thermal management component configured to transport heat towards or away from the plurality of battery cells.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a chassis of a heavy-duty machine with battery towers in spaces left by removing a previous powertrain, according to at least one example.

FIG. 2 illustrates a battery tower assembly using pouch format battery cells with terminals at opposite ends of the battery cells, according to at least one example.

FIG. 3 illustrates a view of a column of a battery tower using battery cells arranged along a vertical frame and illustrating heat transfer systems for thermal management of the battery tower, according to at least one example.

FIG. 4 illustrates a battery tower assembly using blade format battery cells with positive and negative terminals at opposite ends of the battery cells, according to at least one example.

FIGS. 5A-5D illustrate components of a structure for a battery tower assembly, according to at least one example.

FIG. 6 illustrates a detail view of components of adjacent battery towers as part of a battery assembly, according to at least one example.

FIG. 7 illustrates a detail view of components of adjacent battery towers as part of a battery assembly, according to at least one example.

FIG. 8 illustrates a detail view of a structure for a battery tower assembly, according to at least one example.

### DETAILED DESCRIPTION

Wherever possible, the same reference numbers will be used throughout the drawings to refer to the same or like parts. In the figures, the left-most digit(s) of a reference number identifies the figure in which the reference number first appears.

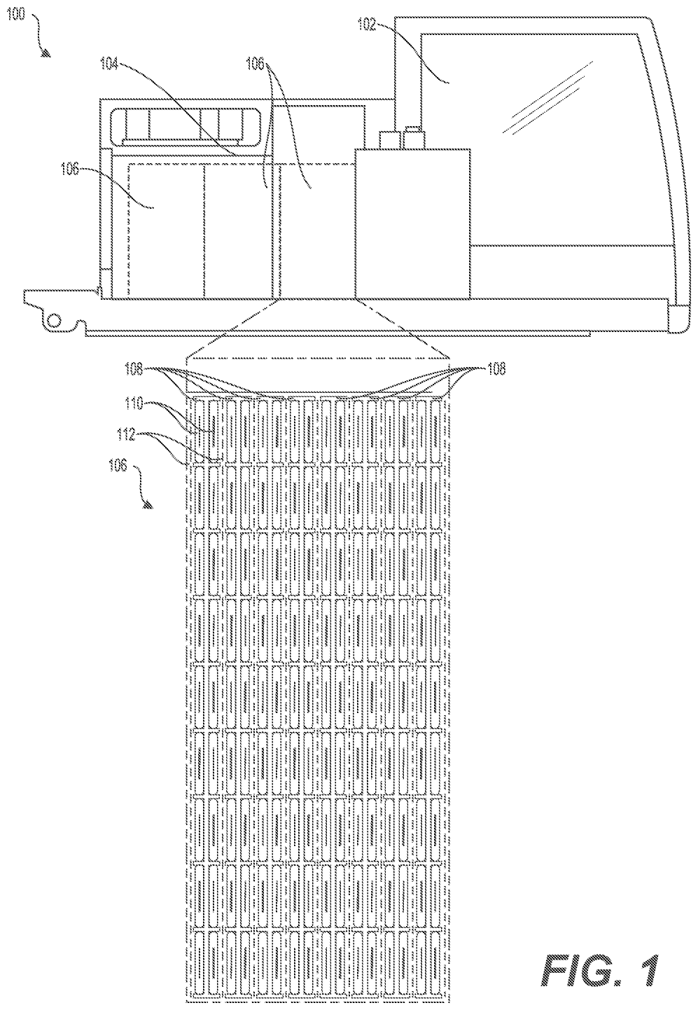

FIG. 1 illustrates a chassis 100 of a heavy-duty machine with battery assemblies 106 in spaces 104 left by removing a previous powertrain, according to at least one example. The chassis 100 may include a cabin 102 for an operator of the heavy-duty machine as well as other control and working components. In such a chassis 100, such as was designed for a diesel fuel powertrain, or other such fuels source, the spaces remaining in the chassis may not be suitable for efficient packing of battery assemblies 106 based on existing battery structures. The systems and structures described herein provide for a battery system that applies a cell-to-pack concept to fill such non-traditional spaces within the chassis 100.

The battery assemblies 106 provide for an integrated structural and thermal design through the use of frames 108 discussed herein that position and support battery cells 110 into battery towers that fit into a non-traditional battery compartment, such as a compartment left behind by a previous propulsion system of an electrified vehicle. The frames 108 support the battery cells vertically such that a largest surface of all the external surfaces of the battery cells 110 contacts the frame, including an integrated thermal regulation device. The battery assemblies 106 use a cell-to-pack configuration to enable efficient packing as well as simplified maintenance and assembly of the battery assemblies 106.

Electrification of heavy-duty equipment, large machines, mining trucks, etc., may involve replacement of a large diesel engine with an electric powertrain that occupies less space and leaves behind large irregular cavities for spaces 104. In some examples, the space no longer occupied by the powertrain may be narrow and tall, such as an engine compartment that does not fit well with common battery module or pack designs. The use of a cell-to-pack (CTP) configuration and assembly concept enables use and efficient packing within the spaces of the chassis 100 previously occupied by the powertrain components while also improving energy density, cooling, and integral structural components.

While traditional battery packs comprise cells, assembled into modules, and then integrated into a pack structure, the CTP design eliminates the need for modules by directly integrating cells into the pack structure. In doing so, the CTP design simplifies the overall architecture, reduces weight and volume, and improves energy density and thermal management. The CTP integrates battery cells directly into a pack without the intermediate step of modules, thereby further enhancing the volumetric energy density of battery mold and system compared to the conventional pack.

The CTP design of the battery assembly 106 enables improved energy density over typical battery arrangements due to the reduced structure by avoiding implementation into a module level. Accordingly, the energy density of the battery assembly 106 is improved over conventional battery pack designs. The battery assembly 106 provides for reduced weight and volume as a result of the higher energy density than a conventional battery system, in particular at least because the battery assembly 106 does not use additional casings, connectors, and other components that may be implemented in a battery module. Additionally, the battery assembly 106 may be produced with fewer steps, complexity, and cost than typical battery packs that are arranged from cells into modules and then into packs.

As depicted in FIG. 1, the battery assemblies 106 fit within spaces 104 left behind by a powertrain assembly. The battery assemblies 106 are designed into a battery tower constructed from a number of structural battery columns with integrated cooling and/or temperature regulating devices. The battery assembly 106 is shown with a plurality of frames 108 and battery cells 110 arranged into the battery columns.

In an example, the battery assembly 106 may use standard VDA format pouch cells for the battery cells 110, which describe a pouch cell with terminal lags on opposite ends and of standard dimensions designed module assembly. In the battery assembly 106, individual battery cells 110 are secured on both sides of a frame 108 to form a column structure. The battery cells 110 may then be electrically coupled in series via electrical connections such as busbars. The battery cells may be oriented such that along the length (e.g., height) of the column, adjacent battery cells 110 have positive and negative terminals alternating. For example, along a first side of the battery assembly 106, the battery cells may be arranged with a positive terminal and the next battery cell vertically in the column may have a negative terminal, such that the battery cells 110 may be electrically coupled with minimal additional structure and components.

The battery cells 110 are stacked in a vertical arrangement such that a largest planar surface of the exterior of the battery cells 110 is exposed to and/or contacts the frame 108 that includes an integrated cooling and/or heat transfer interface. The frame 108 provides a support structure and also provides for heat transfer to and/or from each of the battery cells 110. The frame 109 has vertical battery cells 110 arranged on each side of the frame 108. The frame 108 may include horizontal protrusions that provide shelves and/or supports to maintain the battery cells 110 in their position and prevent the battery cells 110 from imparting a load onto the battery cells 110 positioned underneath. The frame 108 provides a thermal interface with one or more cooling devices, such as heat pipes and/or thermal regulation devices. In this manner, the frame 108 includes the thermal regulation devices contacting the largest surfaces of the battery cells 110 and providing improved thermal transfer to the thermal regulation devices through the surface of the battery cells 110. The frame 108 provides for a cell pair (e.g., a pair of battery cells 110) to be positioned on opposite sides of the frame 108 (with cell pairs stacked vertically about the thermal regulation device and thereby reduce the number of thermal regulation devices needed for the battery module.

In some examples, the battery cells 110 may be electrically connected in series starting from one end of the column (e.g., at a top or bottom of the battery assembly 106) and continuously connect in series with the battery cells 110 along the length of the frame 108 and then along the length in an opposite direction on the opposite end of the battery cells 110. In this manner, the positive and negative terminals of the battery cells 110 are adjacent along a column in the battery assembly 106.

The frame 108 includes a heat transfer component, such as a thin metallic heat pipe (e.g., a strip or sheet of metal). The frame 108 is sandwiched between battery cells 110 on either side. The heat transfer system or component may be integral with or in addition to the frame 108 and be positioned between the battery cells 110 in the column. The heat transfer system enables cooling of battery cells 110 in a passive and/or active manner.

A thin heat-transfer medium is positioned between the vertical columns of the battery cells 110, for example along the frame 108 such that the flat surfaces of the battery cells 110 (particularly the surfaces having the largest surface area of all the surfaces of the battery cells) are in contact with the heat-transfer medium. A single heat-transfer medium may be provided between two columns of battery cells 110, such that each battery cell 110 is in physical contact on at least one surface with the heat-transfer medium. In some examples, a heat transfer medium or system may be positioned between each column of battery cells such that each battery cell 110 contacts the heat-transfer medium on at least two surfaces.

The heat-transfer medium of the frame 108 may include an active cooling system such as liquid cold plate or passive cooling device such as heat pipes, vapor chambers, and other such components, so that heat generated from the battery cells 110 is transported along the length of the frame 108 (e.g., along a vertical plane) to a first end of the frame 108 where a second heat-transfer medium, such as a cold plate, is positioned and thermally coupled with the heat-transfer medium of the frame 108 to provide consistent and continual heat removal. In some examples, the heat transfer systems may use passive cooling, evaporative cooling, active cooling, conduction, convection, or any other mechanism to transfer heat along the heat-transfer medium of the frame to a second heat transfer system to transport heat away from the battery assembly 106.

A compressible member 112 is positioned on an outside surface of the battery cells 110. As depicted in FIG. 1, the battery cells 110 contact the frame 108 on a first lateral surface and contact the compressible member 112 on a second lateral surface opposite the first lateral surface. The compressible member may include a foam, plastic, composite, or other material to provide cell compression to the battery cells 110 as may be required for pouch cell batteries. In some examples, the compressible member may include a shielding component to shield, insulate, and/or otherwise prevent heat from traveling between adjacent battery cells 110.

The frames 108 that support the battery cells 110 provide for an expandable structure that may be used to build the battery assembly 106 into any desirable shape or configuration using the frames 108. In particular, odd shaped or oddly dimensioned compartments of the chassis 100 can be filled with battery assemblies 106 built using the systems described herein. A single tower of battery cells 110 may be formed by a frame 108 with battery cells 110 in receptacles on two opposing sides of the frame 108, with the receptacles shaped and sized to receive and maintain battery cells 110 in a vertical orientation. The vertical orientation may be defined such that the thickness of the battery cells 110 is perpendicular to the length of the frame 108 and the length of the battery cells 110 is perpendicular to both the length of the frame 108 and the thickness. The battery cells 110 of the battery tower are connected to one another in series, with adjacent battery towers connected one to another. The battery towers and/or battery assembly 106 may be sized and/or designed to meet or reach a target voltage, for example including a target voltage that remains below a threshold for various operating, maintenance, and/or safety reasons.

The battery assembly 106, with the battery cells 110 oriented vertically, as shown in FIG. 1, with the surface of the battery cell 110 having the largest surface area of all the surfaces on the battery cell 110 (e.g., the surface defined by the length and width of the battery cell 110) provides for increased surface area contact and thermal transfer to heat transfer components and systems of the battery assembly 106. The increased heat transfer through the large surface area of the face of the battery cell 110 allows for improved battery performance, lifespan, and safety. Further, due to the increased thermal conductivity to the heat transfer components, the battery assembly 106 may be charged and/or discharged at a more rapid rate without overheating or damaging the battery assembly 106. The battery assembly 106 provides for improved thermal control and uniformity across the battery cells 110 that provides the benefits above as well as ensuring optimal performance under various operating conditions.

In an example, the battery cells 110 may include automotive blade cells, e.g., an L600 blade cell having dimensions of about 590 mm in length by about 120 mm in width by about 22 mm in thickness. The automotive blade cells include positive and negative terminals at opposite ends of the battery cell 110 along the length. Unlike a pouch cell design, the automotive blade cells may be enclosed and/or encased in hard prismatic cases with certain pre-compression forces.

The automotive blade cells may be stacked vertically, as shown in FIG. 1, and secured to a frame 108 and then electrically connected in series in the same manner as described above, e.g., with connections from positive to negative or negative to positive terminals along a first side of the battery tower and along a second side of the battery cower to place the battery cells 110 in electrical connection in series. The frame 108 includes a heat transfer component, such as a heat pipe, metal sheet, metal bar, cold plate, or other heat transfer system that is in contact with the automotive blade cells, for example using a thermally conductive paste to secure the battery cells 110 into the frame 108. The heat transfer component may include one, two, three, or more heat transfer components that may transfer heat in parallel towards a first end of the battery assembly 106, where a cold plate or other active cooling component is provided.

In some examples, due to the thickness of the blade cells, which may be, for example, twice as thick as the pouch cell (or generally thicker), an additional heat-transfer plate may be added to the outside face of the cells and in between two adjacent battery towers, such that each battery cell 110 contacts a heat-transfer system on at least two opposing surfaces when in the battery assembly 106.

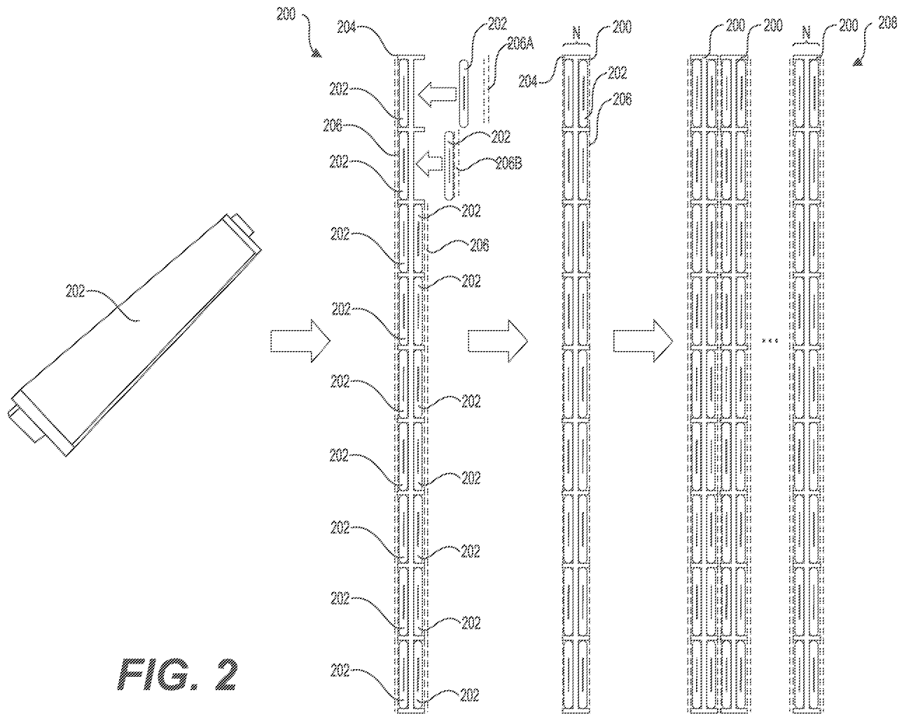

FIG. 2 illustrates a modular battery assembly using pouch format battery cells with terminals at opposite ends of the battery cells, according to at least one example. The modular battery assembly is based around columns 200 of battery cells that may be arranged into suitable battery assemblies to fit within compartments in a chassis of a heavy-duty machine, such as an electrified version of a previously diesel-powered machine. FIG. 2 illustrates the columns 200 supporting battery cells 202. The columns 200 are used for forming a unit that may be assembled and repeated “N” times within a battery assembly 208 to meet the size constraints and limitations of the particular compartment within the chassis of the heavy-duty machine.

In an example, the modular battery assembly may use a VDA 590 pouch cell. The approximate cell dimensions of such a pouch cell may be approximately 540 mm in length, approximately 100 mm in width, and approximately 11 mm in thickness with positive and negative terminals on the opposite ends of the pouch cell. Other shapes, sizes, and configurations of battery cells may be implemented in place of the pouch cells, with corresponding adjustments to the structure of a frame 204 to support and secure the pouch cells in position in a vertical column.

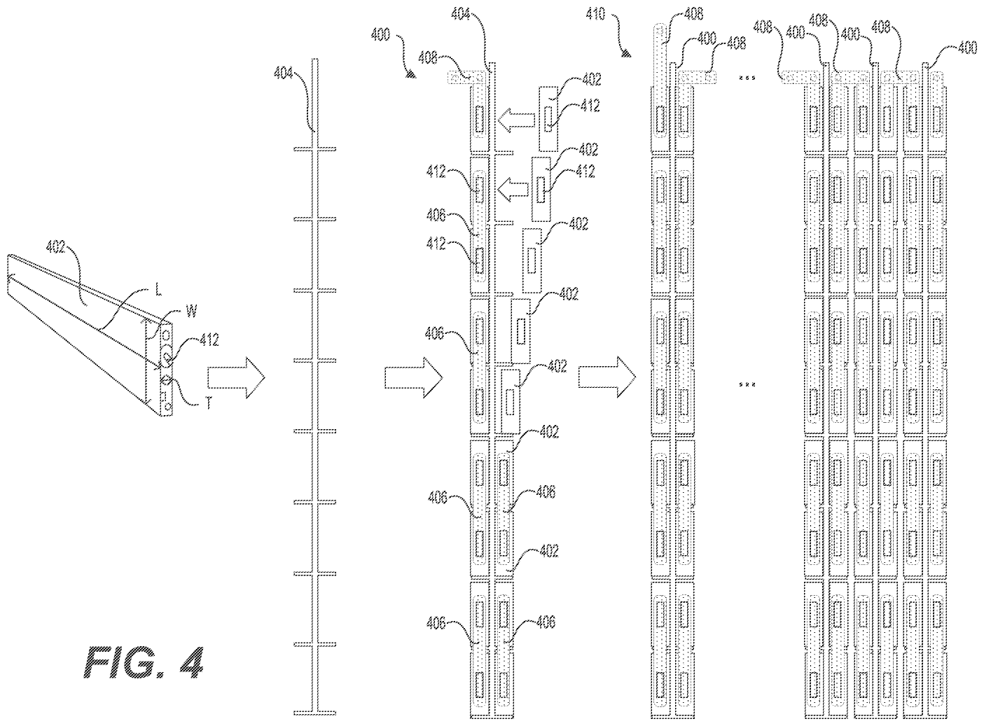

The battery cells 202 are held within the frame 204. The frame 204 provides a vertical structure with columns of battery cells 202 along each side of the vertical structure. The frame 204 includes a vertical portion extending from a first end to a second end along a first direction and also includes a plurality of protrusions that extend perpendicular, or nearly perpendicular from the vertical portion. The protrusions are spaced apart and have a length such that the frame 204 defines a plurality of receiving areas to receive and secure the battery cells 202. With the battery cells 202 in place on the frame 204, the battery cells 202 may be permanently and/or releasably secured to the frame 204. In some examples the battery cells 202 may be releasably secured such that replacement of the battery cells 202 only requires removal and replacement, without having to overcome a permanent or semi-permanent securing mechanism. The terminals of the battery cells 202 may then be electrically coupled together, such as depicted in FIG. 4.

The frame 204 includes one or more heat transfer systems along a height (e.g., length) of the frame 204 from a first end to a second end. The battery cells 202 are in contact with the heat transfer system on an inner (e.g., facing a center of the frame 204) surface of the battery cells 202. The heat transfer system is positioned at a center of the column 200 with the battery cells 202 on either side of the heat transfer system. For example, the heat transfer system may include one or more heat pipes such as metal conductors extending along the length of the frame 204. The battery cells 202 are in contact with the heat transfer system to provide for thermal transfer to the heat transfer system and control and/or cooling of the battery cells 202. The battery cells 202 are arranged along the frame 204 such that the flat surfaces of the battery cells 202 (particularly the surfaces having the largest surface area of all the surfaces of the battery cells) are in contact with the heat-transfer system. A single heat-transfer medium may be provided in a center of the column 200. In some examples, a heat transfer medium may be provided on both surfaces of the battery cells 202.

The heat-transfer system along the length of the frame 204 may include an active cooling system such as liquid cold plate or passive cooling device such as heat pipes, vapor chambers, and other such components, so that heat generated from the battery cells 202 is transported along the length of the frame 204 (e.g., along a vertical plane) to a first end of the frame 204 where a second heat-transfer system, such as a cold plate, is positioned and thermally coupled with the heat-transfer system of the frame 204 to provide heat removal and/or temperature regulation for the battery cells 202. The second heat transfer system may couple to a first heat transfer system (e.g., heat pipe) of multiple columns 200 to provide active cooling across the battery assembly 208. In some examples, the heat transfer systems may use passive cooling, evaporative cooling, active cooling, conduction, convection, or any other mechanism to transfer heat along the heat-transfer medium of the frame to a second heat transfer system to transport heat away from the battery assembly 208.

The column 200 is used to create the battery assembly 208 by stacking and connecting a number of columns 200 side-by-side integrated with a single cold plate at one end (e.g., on top) and providing power connections between columns 200 as well as out of the battery assembly 208. In some examples a second cold plate may be positioned at a second end of the column 200 for additional cooling capacity and cooling consistency across the cells (e.g., to avoid one end of the columns 200, such as the end farther from the cold plate, potentially being warmed than an opposite end). The battery assembly 208 is then placed within a protective housing to form a battery tower for use in a heavy-duty chassis.

In an example of a battery assembly 208, such as for a lithium iron phosphate (LFP) battery cell 202 such as a VDA 590 cell (e.g., 3.20 V, 115 Ah), a column 200 in this example may include eighteen battery cells 202 connected in series, which results in a nominal column voltage 57.6 V. The approximate dimension of a column 200 is (as a function of detailed column design and material selection) in a range of thirty to forty millimeters in thickness, 650 millimeters in width and about 1,000 millimeters in height or length. Accordingly, a single string 750-volt battery system of 86 kWh may be constructed using thirteen (13) columns 200 in series and leading to a battery assembly 208 having dimensions of approximately 520 millimeters in thickness by 650 millimeters in width and 1,200 mm in height. This example corresponds to an approximate energy density of about 212 Watt-hours/liter.

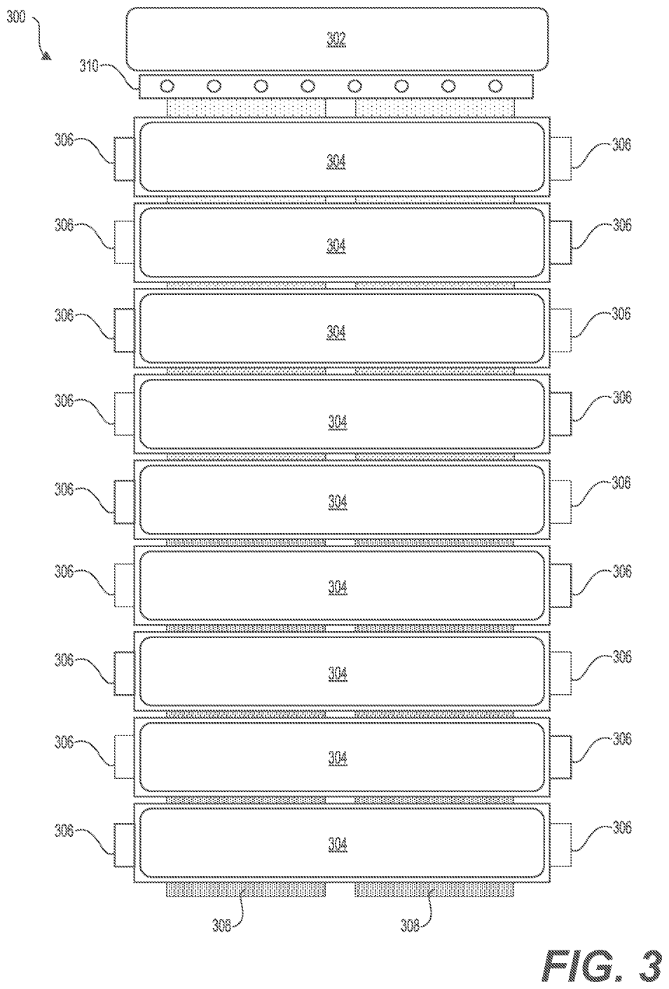

FIG. 3 illustrates a view of a column 300 of a battery tower using battery cells 304 arranged along a vertical frame and illustrating heat transfer systems for thermal management of the battery tower, according to at least one example. The column 300 is shown including a power box 302 for managing the battery assembly. The power box 302 may couple to multiple columns and provide battery management operations for the battery assembly. The column 300 shows battery cells 304 arranged vertically stacked along the height (or length) of the column 300. The battery cells 304 have terminals 306 at opposite ends along the lengths of the battery cells 304. The terminals 306 may be arranged, along each side of the column 300, with alternating positive and negative terminals such that connections between terminals may be made to connect the battery cells 304 in series.

The column 300 further includes a first heat transfer system 308 and a second heat transfer system 310. The first heat transfer system 308 may include two (or more or less) heat pipes for providing heat transfer along the height of the column 300. The first heat transfer system 308 is depicted as two heat pipes that may form at least a portion of a support frame for holding the battery cells 304. The battery cells 304 are in contact with the first heat transfer system 308 on an inner surface of the battery cells 304. The first heat transfer system 308 is positioned sandwiched between stacked columns of battery cells 304. The multiple heat pipes of the first heat transfer system 308 may, in some examples include a single component formed of a heat conductive material such as a metal (e.g., copper, aluminum, or other such material with a comparable thermal conductivity rate). The first heat transfer system 308 may include one or more heat pipes such as metal conductors extending along the height of the column 300. The battery cells 304 are in contact with the first heat transfer system 308 to provide for thermal transfer to the first heat transfer system 308 and control and/or cooling of the battery cells 304. The battery cells 304 are arranged in the column 300 such that the flat surfaces of the battery cells 304 (particularly the surfaces having the largest surface area of all the surfaces of the battery cells 304) are in contact with the first heat transfer system 308. The first heat transfer system may have one or more contact areas with each of the battery cells 304 through which the heat is transferred. In some examples the surface area may be increased by increasing the number of heat pipes and/or the width of the heat pipes to provide for additional thermal transfer. Weight, cost, and material considerations may lead to an optimization of the dimensions and/or thermal conductivity of the first heat transfer system based at least in part on expected or actual heat generated by battery cells 304 during charging and discharging operations.

The first heat transfer system 308 may include an active cooling system such as liquid cold plate or passive cooling device such as heat pipes, vapor chambers, and other such components, so that heat generated from the battery cells 304 is transported along the length of the column 300 (e.g., along a vertical plane) to a first end of the column 300 where a second heat transfer system 310, such as a cold plate, is positioned and thermally coupled with the first heat transfer system 308 to provide heat removal and/or temperature regulation for the battery cells 304. The second heat transfer system 310 may couple to the first heat transfer system 308 across multiple columns 300 to provide active cooling across the battery assembly 208. In some examples, the heat transfer systems (e.g., the first and/or the second heat transfer systems) may use passive cooling, evaporative cooling, active cooling, conduction, convection, or any other mechanism to transfer heat along the length of the column as well as away from the column 300.

FIG. 4 illustrates a battery tower assembly 410 using blade format battery cells 402 with terminals 412 at opposite ends of the battery cells 402, according to at least one example. In the illustration of FIG. 4, the battery cells 402 are shown using automotive L600 blade cells. In at least one example, the battery cells 402 may have approximate cell dimensions of about 590 millimeters in length (L), 120 millimeters in width (W), and 22 millimeters in thickness (T) with positive and negative terminals on the opposite ends of the battery cell 402. The battery cells 402 are secured within a frame 404 to form a column 400 that can be repeated to form the battery tower assembly 410. The battery cells 402 are electrically connected in-series with busbars 406 from top to bottom along a first edge of the column 400 and bottom to top along a second edge of the column 400. The busbars 406 connect the terminals 412 together and specifically connect sets of positive and negative terminals to connect the set of battery cells 402 arranged along the frame 404 in series together.

The frame 404 includes a heat transfer system along the length of the frame 404 with the battery cells 402 pressed against the heat transfer system to provide for thermal conductivity between the surface of the battery cell 402 and the heat transfer system. The heat transfer system may couple to a second heat transfer system at one end of the column 400 to provide for heat transfer away from the battery tower assembly 410.

The battery tower assembly 410 is formed by stacking, adjacent to one another, a set of columns 400. The adjacent columns are electrically connected by busbars 408 to produce a battery tower assembly 410 including the battery cells 402 across multiple columns 400 connected in series. The battery cells 402 may be easily replaced as-needed without significant re-working or disassembly of the battery tower assembly 410 since the battery tower assembly 410 is not arranged in a typical module fashion as described herein. The battery tower assembly 410 is then placed inside a protective enclosure to form a battery tower that can be deployed and/or positioned within a chassis of an electrified vehicle. As described herein, the column approach allows for tall and narrow battery structures without placing undue loads on battery cells at the bottom of the columns 400 and also enables the battery tower to be sized and shaped to fit within powertrain compartments of an electrified vehicle that previously housed a fuel-based powertrain.

In an example, a lithium iron phosphate (LFP) L600 cell (e.g., 3.20 V, 220 Ah) may be used to form a column 400 including, for illustrative purposes, a column 400 with eighteen battery cells 402 connected in series, which results in a nominal column voltage 57.6 V. The approximate dimension of a column 400 may be in a range of 50 to 60 millimeters in thickness, a width of about 650 millimeters, and a height of about 1,000 millimeters. The column 400 may include more or less than eighteen cells in other configurations and arrangements, for example by adding additional height to the column 400 for stacking additional battery cells 402. The column 400 may also have less than eighteen battery cells 402 by reducing the height of the column 400. The specific number of battery cells 402 and number of columns 400 may be dictated by power requirements and space shape and availability within the chassis of the heavy-duty vehicle. Accordingly, a single string 750-volt nominal battery system of 164.7 kWh may be constructed using thirteen (13) columns 400 of eighteen battery cells 402 in series and leading to a battery tower assembly 410 having dimensions of about 780 millimeters in thickness, about 650 millimeters in width, and about 1,200 millimeters in height. This design may correspond to an approximate pack-level energy density of about 270 Watt-hours/liter.

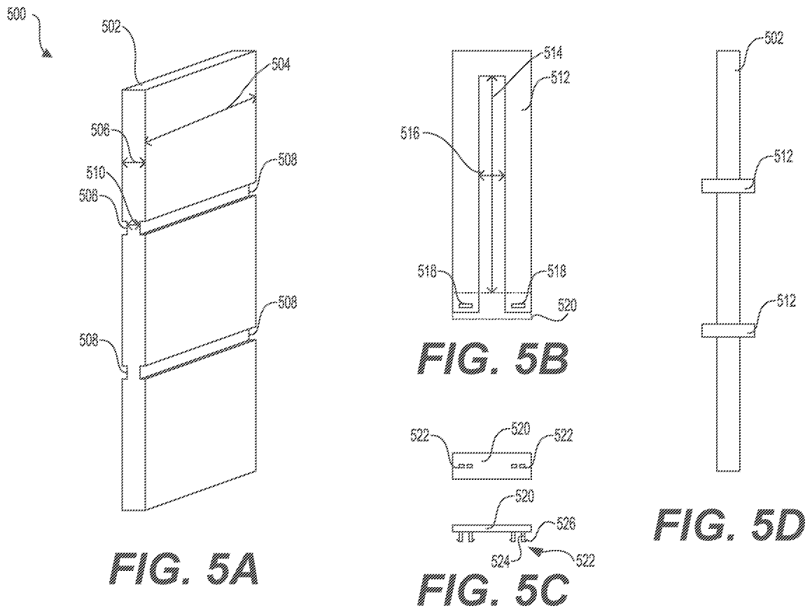

FIGS. 5A-5D illustrate components of a structure for a battery tower assembly 500, according to at least one example. The battery tower assembly 500 may be an example of the structure of the battery assemblies 106 or other such structures described herein. The battery tower assembly 500 includes a vertical structure 502, a u-shaped component 512 and an end component 520. The structure of the battery tower assembly 500 allows for simple battery cell assembly and removal as well as limited structural components and bulk. The shelf design and the structure thereof provides for decreased weight as well as ease of assembly and disassembly. The battery tower assembly 500 enables single or double sided cooling and/or heating for battery cells. Additionally, the battery tower assembly includes an integrated thermal structure with a structural thermal management component (e.g., a cold plate) with slots or grooves for shelf support. The shelf design of the battery tower assembly 500 allows for a modular design for ease of assembly and disassembly. The battery tower assembly 500 orients the largest surface area faces of the battery cells against the heat management systems (e.g., cold plate) for efficient heat transfer and management of the battery cells.

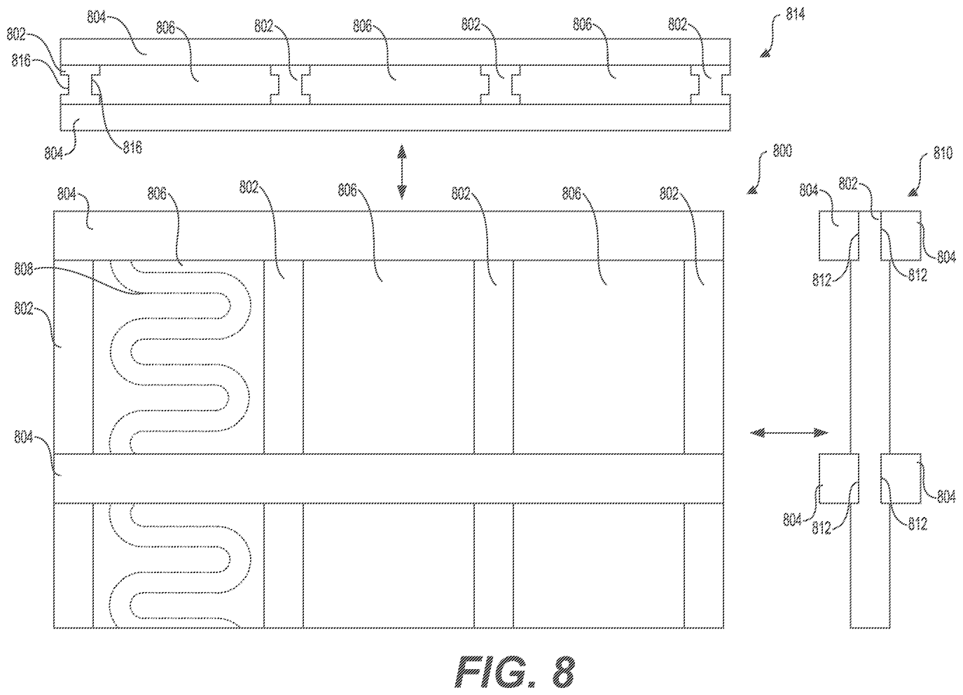

FIG. 5A illustrates the vertical structure 502 of the battery tower assembly 500. The vertical structure 502 may include a cold plate or other heat transfer structure or device. The vertical structure 502 may be formed of a metal such as aluminum, a plastic, a composite, or be a combination of different materials, such as shown and described with respect to FIG. 8. The vertical structure 502 may have a variable height and may be modular to be configurable to fit within an engine compartment or other space as-needed. The vertical structure 502 has a width 504 and a thickness 506.

The vertical structure 502 includes a series of slots or grooves 508 arranged along the height of the vertical structure 502. The grooves 508 are disposed perpendicular to the height of the vertical structure 502, with the grooves 508 aligned across the width 504. The grooves 508 are arranged on the surfaces of the vertical structure 502 with a first groove and a second groove on opposite sides and aligned with each other. The grooves 508 have a first depth such that a thickness 510 of the vertical structure 502 at the location of the grooves 508 is less than the thickness 506. The grooves therefore define a slot along each face of the vertical structure 502. The grooves 508 provide for support and easy insertion and removal of shelf components such as the u-shaped component 512 and the end component 520 depicted in FIGS. 5B and 5C.

FIG. 5B depicts a u-shaped component 512 of the shelf. The u-shaped component 512 may be formed of metal, plastic, or any other rigid material. The thickness of the u-shaped component 512 may correspond to a height of the groove 508. The u-shaped component 512 has a first end and two distal ends that extend along a length 514 of the u-shaped component 512. The length 514 may correspond to the width 504 of the vertical structure 502. The u-shaped component 512 defines a width 516 between the distal ends and the width 516 corresponds to the thickness 510. The width 516 may be greater than the thickness 510 but less than the thickness 506 such that the u-shaped component 512 fits in the grooves 508 at least partially surrounding the vertical structure 502.

At the distal ends of the u-shaped component 512 interfaces 518 are positioned to receive a corresponding interface of the end component 520. In some examples the interfaces 518 may define and/or include openings to receive a protrusion or clip from the end component 520. The end component 520 and the u-shaped component 512, when combined together and coupled, may form a perimeter that surrounds the vertical structure 502.

The end component 520, depicted in FIG. 5C, may have a thickness that corresponds to the thickness of the u-shaped component 512. The end component 520 includes protrusions 522 that couple with the interfaces 518 to releasably secure the end component 520 to the u-shaped component 512. The protrusions 522 are depicted with an arm 524 and an angled end 526 configured to fit into the openings of the interfaces 518.

As shown in FIG. 5D, the vertical structure 502 may be arranged with the u-shaped components 512 and end components 520 surrounding the vertical structure 502. The u-shaped components 512 fit within the grooves 508 and the end components 520 secure to the ends of the u-shaped components 512 to prevent the u-shaped components 512 from being removed or falling off of the vertical structure 502.

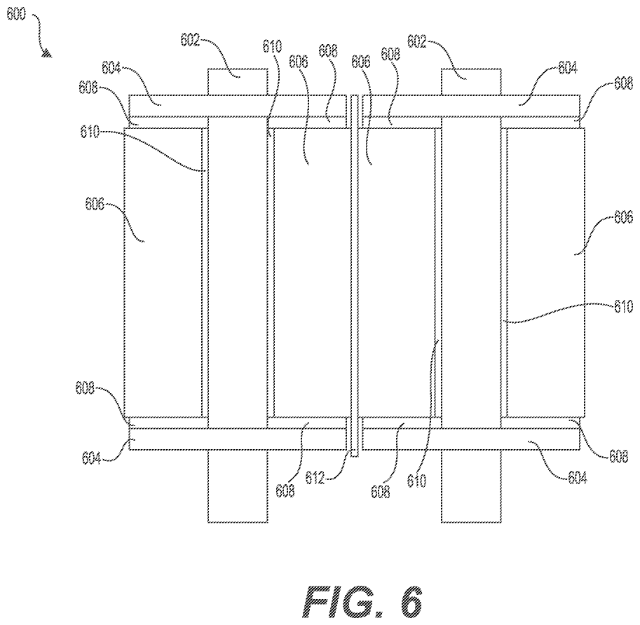

FIG. 6 illustrates a detail view 600 of components of adjacent battery towers as part of a battery assembly, according to at least one example. The detail view 600 shows vertical structures 602 with shelves 604 attached thereto, such as the structure described with respect to FIGS. 5A-5D. The vertical structures 602 and shelves 604 form battery receiving areas to receive battery cells 606. In some examples, the battery cells 606 are surrounded, at least partially, but a cushioning material 608 between the battery cells 606 and the shelves 604 and cushioning material 610 between the vertical structure 602 and the battery cells 606.

The vertical structures 602 and battery cells 606 of a first battery tower module is positioned with a cushioning material 612 between the adjacent battery tower modules. The cushioning materials described herein may include compressible foam, rubber, neoprene, or other such materials.

The vertical structures 602 include cooling plates to provide cooling to the battery cells 606. The detail view 600 shows an example of single-sided cooling for the battery cells 606. The single-sided cooling is characterized by each battery cell 606 interfacing the cooling plate of the vertical structure 602 with one of the largest faces of the battery cells 606. The opposite largest face of the battery cells 606 faces outwards and is positioned adjacent the cushioning material 612.

In some examples, the cushioning material 612 may be replaced and/or supplemented by a heating component between the battery tower modules. The battery cells 606 interface with the cooling plate with a first of the largest surfaces of the battery cell 606 and interfaces with the heating component with a second of the largest surfaces of the battery cell 606 opposite the first surface. The heating component may be used to provide heat to the battery cells 606 to improve performance, such as when operating in low temperature ambient environments.

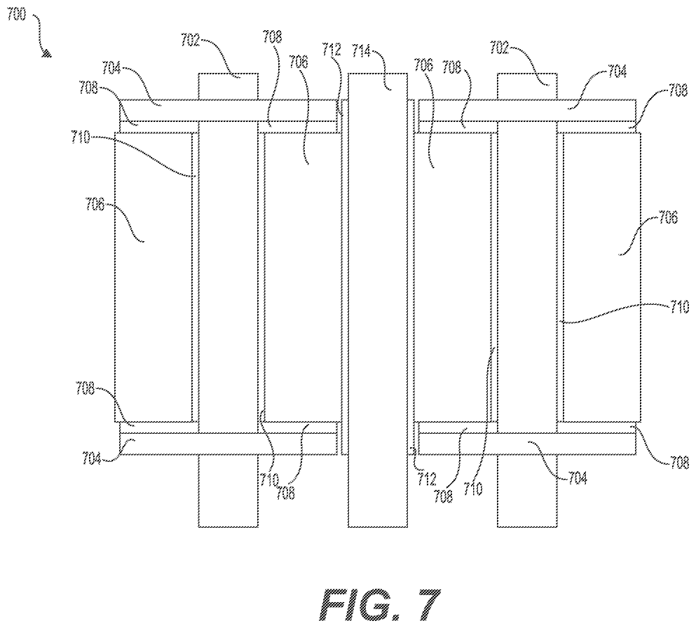

FIG. 7 illustrates a detail view 700 of components of adjacent battery towers as part of a battery assembly, according to at least one example. The detail view 700 shows vertical structures 702 with shelves 704 attached thereto, such as the structure described with respect to FIGS. 5A-5D. The vertical structures 702 and shelves 704 form battery receiving areas to receive battery cells 706. In some examples, the battery cells 706 are surrounded, at least partially, but a cushioning material 708 between the battery cells 706 and the shelves 704 and cushioning material 710 between the vertical structure 702 and the battery cells 706.

The vertical structures 702 and battery cells 706 of a first battery tower module is positioned with a cushioning material 712 between the adjacent battery tower modules. The cushioning materials described herein may include compressible foam, rubber, neoprene, or other such materials.

The vertical structures 702 include cooling plates to provide cooling to the battery cells 706. The detail view 700 shows an example of double-sided cooling for the battery cells 706. The double-sided cooling is characterized by each battery cell 706 interfacing the cooling plate of the vertical structure 702 with one of the largest faces of the battery cells 706. The opposite largest face of the battery cells 706 faces outwards and is positioned adjacent the cushioning material 712 and/or another cooling plate.

In some examples, the cushioning material 712 may be replaced and/or supplemented by a heating component between the battery tower modules. The battery cells 706 interface with the cooling plate with a first of the largest surfaces of the battery cell 706 and interfaces with the heating component with a second of the largest surfaces of the battery cell 706 opposite the first surface. The heating component may be used to provide heat to the battery cells 706 to improve performance, such as when operating in low temperature ambient environments. In this manner, the heating component and cooling plate 714 may be used to regulate and control the thermal properties of the battery cells 606 during use, charging, storage, or other operation.

FIG. 8 illustrates a set of detail views of a structure for a battery tower assembly 800, according to at least one example. The battery tower assembly 800 is shown that includes different configurations that can be used for a cooling plate such as an aluminum cold plate or an aluminum framework that utilizes multiple molded plastic cooling plates.

The battery tower assembly 800 includes beams 802, shelves 804, and cooling plates 806. The beams 802 may include a metal frame such as an aluminum I-beam shape. The beams 802 include slots 816, as depicted in view 814, to receive the cooling plates 806. The cooling plates 806 are configured to interface with the beams 802 at the slots 816. The cooling plate 806 is disposed between adjacent beams. The cooling plates 806 may include plastic cooling plates that are housed between the beams 802. The beams 802 include channels 812 as shown in view 810 similar to the structures described herein. The shelves 804 may be similar or identical to the structures shown and described with respect to FIGS. 5A-5D.

The cooling plates 806 may include a molded plastic cooling plate design. The molded plastic design may include a molded plastic shell that defines an internal geometry for a coolant to flow. The molded design includes a channel 808 that may be molded within the plastic cooling plate. The cooling plate 806 may also include a slot to allow for space for the shelves 804, but may not bear weight. The channel 808 may define a flow channel for a fluid to flow through the cooling plate 806 to provide heat transfer from the battery tower assembly 800.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features, it is to be understood that the subject matter defined in the appended claims is not necessarily limited to the specific features described. Rather, the specific features are disclosed as illustrative forms of implementing the claims.

### INDUSTRIAL APPLICABILITY

The present disclosure provides systems and methods for a battery tower assembly for fitting within a chassis of a heavy-duty machine in spaces left by removing a previous powertrain. In such a chassis, such as was designed for a diesel fuel powertrain, or other such fuels source, the spaces remaining in the chassis may not be suitable for efficient packing of typical battery assemblies based on existing battery structures. The systems and structures described herein provide for a battery system that applies a cell-to-pack concept to fill such non-traditional spaces within the chassis.

Electrification of heavy-duty equipment, large machines, mining trucks, etc., may involve replacement of a large diesel engine with an electric powertrain that occupies less space and leaves behind large irregular spaces. In some examples, the space no longer occupied by the powertrain may be narrow and tall, such as an engine compartment that does not fit well with common battery module or pack designs. The use of a cell-to-pack (CTP) configuration and assembly concept enables use and efficient packing within the spaces of the chassis previously occupied by the powertrain components while also improving energy density, cooling, and integral structural components.

While traditional battery packs comprise cells, assembled into modules, and then integrated into a pack structure, the CTP design eliminates the need for modules by directly integrating cells into the pack structure. In doing so, the CTP design simplifies the overall architecture, reduces weight and volume, and improves energy density and thermal management. The CTP integrates battery cells directly into a pack without the intermediate step of modules, thereby further enhancing the volumetric energy density of battery mold and system compared to the conventional pack.

The CTP design of the battery assembly described herein enables improved energy density over typical battery arrangements due to the reduced structure by avoiding implementation into a module level. Accordingly, the energy density of the battery assembly is improved over conventional battery pack designs. The battery assembly provides for reduced weight and volume as a result of the higher energy density than a conventional battery system, in particular at least because the battery assembly does not use additional casings, connectors, and other components that may be implemented in a battery module. Additionally, the battery assembly may be produced with fewer steps, complexity, and cost than typical battery packs that are arranged from cells into modules and then into packs.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A battery tower comprising:
a plurality of modular structures shaped to fit within an existing compartment of a heavy-duty vehicle, wherein a modular structure of the plurality of modular structures comprises:
a vertical frame oriented along a first direction defining a plurality of grooves with an individual groove of the plurality of grooves oriented along a second direction substantially perpendicular to the first direction and extending across a width of the vertical frame;
a plurality of shelves connected to the vertical frame, an individual shelf of the plurality of shelves configured to fit within the individual groove and at least partially encircle a perimeter of the vertical frame;
a plurality of battery cells positioned adjacent the vertical frame and supported by the plurality of shelves, a battery cell of the plurality of battery cells having a rectangular prism shape with a length, width, and thickness, wherein the battery cell of the plurality of battery cells is positioned with the length and the thickness arranged perpendicular to the first direction; and
a compressible material positioned on an external surface of the plurality of battery cells to provide a compressible cushion between adjacent modular structures.

2. The battery tower of claim 1, wherein the vertical frame comprises at least one of a heat pipe; a thermally conductive material, a cold plate; a vapor chamber; or another heat transfer device along the first direction from a first end of the vertical frame to a second end of the vertical frame to provide thermal transfer along the first direction.

3. The battery tower of claim 1, wherein:
the vertical frame has a first width at first positions associated with the plurality of grooves and a second width at second positions between the plurality of grooves; and
each of the plurality of shelves comprises:
a u-shaped component defining an opening having a third width, wherein the third width is less than the second width; and
an end component configured to couple to distal ends of the u-shaped component.

4. The battery tower of claim 3, wherein:
the u-shaped component comprises a first interface adjacent a first distal end of the u-shaped component and a second interface adjacent a second distal end of the u-shaped component;
the end component comprises a third interface adjacent a first end of the end component and a fourth interface adjacent a second end of the end component; and
the third interface couples with the first interface and the fourth interface couples with the second interface to form the individual shelf.

5. The battery tower of claim 4, wherein:
the first interface and the second interface each define respective openings; and
the third interface and the fourth interface each define a retaining clip configured to securely interface with the respective openings of the first interface and the second interface.

6. The battery tower of claim 1, further comprising a thermal management component positioned between adjacent modular structures of the plurality of modular structures, the thermal management component configured to transport heat towards or away from the plurality of battery cells.

7. The battery tower of claim 1, wherein the modular structure further comprises a thermal management component positioned between the plurality of battery cells and the vertical frame, the thermal management component configured to transport heat towards or away from the plurality of battery cells.

8. A battery tower module comprising:
a frame comprising:
a vertical structure defining a groove across a width of the vertical structure, the vertical structure having a first width at the groove and a second width adjacent the groove;
a shelf including:
a u-shaped component defining a first width between opposite sides of the u-shaped component; and
an end component configured to couple to distal ends of the u-shaped component;
a first heat transfer device arranged along a length of the frame;
a second heat transfer device thermally coupled with the first heat transfer device adjacent a first end of the frame; and
a battery cell positioned adjacent the vertical structure and supported by the shelf.

9. The battery tower module of claim 8, wherein the vertical structure comprises:
a plurality of beams extending along a height of the vertical structure; and
one or more cooling plates disposed between adjacent beams of the plurality of beams, the one or more cooling plates comprising the first heat transfer device.

10. The battery tower module of claim 9, wherein:
a beam of the plurality of beams defines:
a first slot on a first side extending along a length of the beam; and
a second slot on a second side extending along the length of the beam; and
the one or more cooling plates are configured to interface with the first slot or the second slot.

11. The battery tower module of claim 10, wherein the one or more cooling plates comprise a molded plastic shell defining a flow channel for transporting a fluid through the one or more cooling plates.

12. The battery tower module of claim 8, wherein the end component being configured to couple to the distal ends of the u-shaped component comprises:
the end component including a first clip adjacent a first end and a second clip adjacent a second end; and
the u-shaped component including interfaces at distal ends of the u-shaped component, the interfaces configured to receive the first clip and the second clip.

13. The battery tower module of claim 8, further comprising a first compressible material disposed on the shelf and a second compressible material disposed against the vertical structure.

14. The battery tower module of claim 8, further comprising a thermal management component positioned between the battery cell and the vertical structure, the thermal management component configured to transport heat towards or away from the battery cell.

15. The battery tower module of claim 8, wherein the frame comprises the first heat transfer device including at least one of a heat pipe; a thermally conductive material, a cold plate; a vapor chamber; or another heat transfer device.

16. A battery module comprising:
a housing shaped to fit within a powertrain compartment of a heavy-duty vehicle after a fuel-based powertrain is removed from a chassis of the heavy-duty vehicle;
a plurality of battery towers arranged within the housing, the plurality of battery towers positioned horizontally with respect to one another, and wherein a battery tower of the plurality of battery towers comprises:
a frame comprising:
a vertical structure defining a groove across a width of the vertical structure, the vertical structure having a first width at the groove and a second width adjacent the groove;
a shelf including:
a u-shaped component defining a first width between opposite sides of the u-shaped component; and
an end component configured to couple to distal ends of the u-shaped component; and
a plurality of battery cells disposed adjacent the vertical structure and supported by the shelf;
a first heat transfer device arranged along a length of the frame; and
a second heat transfer device thermally coupled with the first heat transfer device adjacent a first end of the frame.

17. The battery module of claim 16, wherein the vertical structure comprises:
a plurality of beams extending along a height of the vertical structure; and
one or more cooling plates disposed between adjacent beams of the plurality of beams, the one or more cooling plates comprising the first heat transfer device.

18. The battery module of claim 17, wherein:
a beam of the plurality of beams defines:
a first slot on a first side extending along a length of the beam; and
a second slot on a second side extending along the length of the beam; and
the one or more cooling plates are configured to interface with the first slot or the second slot.

19. The battery module of claim 18, wherein the one or more cooling plates comprise a molded plastic shell defining a flow channel for transporting a fluid through the one or more cooling plates.

20. The battery module of claim 16, wherein the end component being configured to couple to the distal ends of the u-shaped component comprises:
the end component including a first clip adjacent a first end and a second clip adjacent a second end; and
the u-shaped component including interfaces at distal ends of the u-shaped component, the interfaces configured to receive the first clip and the second clip.
